(19) United States
(12) Patent Application Publication
(10) Pub. No.: US 2012/0134912 A1
(43) Pub. Date: May 31, 2012

(54) PROCESS FOR THE RECOVERY OF HYDROCHLORIC ACID

(76) Inventors: Avram Baniel, Jerusalem (IL); Robert P. Jansen, Portela (PT)

(21) Appl. No.: 13/132,573

(22) PCT Filed: Nov. 19, 2009
(86) PCT No.: PCT/IL09/01091

§ 371 Date: Sep. 15, 2011

(30) Foreign Application Priority Data
Dec. 2, 2008 (IL) 195,646

(51) Int. Cl. C01B 7/07

(52) U.S. Cl. 423/488

(57) ABSTRACT

The Invention provides a process for the recovery of gaseous HCl comprising: a) providing an HCl-carrying extractant comprising: (i) an oil soluble amine which amine is substantially water insoluble both in free and in salt form; and (ii) a solvent for the amine and organic acid; b) contacting the HCl-carrying extractant with at least one non-volatile mineral acid, and c) stripping gaseous HCl, whereby HCl-depleted extractant and gaseous HCl are formed.

The present invention relates to a process for the recovery of hydrochloric acid from an aqueous solution comprising at least one of HCl and chloride salt.

The term “hydrochloric acid,” as used in the present specification, is intended to denote all forms of hydrochloric acid, including aqueous solutions of hydrogen chloride (HCl) and gaseous phases containing the same. Such acid solutions are broadly present in industrial practice. They are used as reagents (e.g., in regeneration of ion-exchangers) and are formed as by-products or co-products of other processes. In the latter case, the hydrochloric acid obtained is frequently quite dilute, typically 5% HCl to 10% HCl, and needs be reconcentrated to the range of over 20%—desirably to about 30%—to be of commercial viability. The alternative of neutralization and disposal is inherently costly.

Concentration of hydrochloric acid by distillation is a well-known technology practiced for many years. Its basic drawback is the high cost of the equipment and the inherent large energy consumption. If various impurities are present in the dilute hydrochloric acid, the concentration by distillation needs to be preceded by some separation step to prevent equipment fouling or contamination of the concentrated hydrochloric acid.

In U.S. Pat. No: 4,291,007 by the present inventor, there is described and claimed a solvent extraction process for the separation of a strong mineral acid from other species present in an aqueous solution and the recovery thereof under reversible conditions utilizing an extractant phase that contains an acid-base-couple (hereinafter referred to as an “ABC solvent”) which obviates the consumption of chemicals for regeneration, comprising the steps of:
a) bringing an aqueous solution containing the mineral acid to be separated into contact with a substantially immiscible extractant phase, said extractant phase comprising:
   i) a strong organic acid, which acid is oil-soluble and substantially water-immiscible, in both free and salt forms;
   ii) an oil-soluble amine, which amine is substantially water-insoluble, in both free and salt forms; and
   iii) a carrier solvent for said organic acid and said amine, wherein the molar ratio of said organic acid to said amine is between about 0.5:2 and 2:0.5,
   whereupon said predetermined mineral acid selectively and reversibly transfers to said extractant phase;
b) separating said two phases; and
c) backwashing said extractant phase with an aqueous system to recover substantially all the mineral acid contained in said extractant phase.

The strong organic acids envisioned for use in the extractant phase of said invention were organic acids which may be defined and characterized as follows: When 1 mol of the acid in a 0.2 molar or higher concentration is contacted with an equivalent amount of 1N NaCl, the pH of the sodium chloride solution decreases to below 3.

Especially preferred for use in said invention were strong organic acids selected from the group consisting of aliphatic and aromatic sulfonic acids, and alpha-, beta- and gamma-chloro and bromo-substituted carboxylic acids, e.g., hexadecylsulfonic acid, didodecylnaphthalene disulfonic acid, alpha-bromo lauric acid, beta-dichloro decanoic acid and gamma dibromo octanoic acid, etc.

The amines of said invention are preferably primary, secondary and tertiary amines singly or in mixtures and characterized by having at least 10, and preferably at least 14, carbon atoms and at least one hydrophobic group. Such commercially available amines as Primene JM-5, and Primene JM-T (which are primary aliphatic amines in which the nitrogen atom is bonded directly to a tertiary carbon atom) and which commercial amines are sold by Rohm and Haas chemical Co.; Amberlite LA-1 and Amberlite LA-2, which are secondary amines sold by Rohm and Haas; Alamine 336, a tertiary tricaprylyl amine (TCA) and Alamine 304, a tertiary trilaurylamine (TLA), both sold by General Mills, Inc., can be used in the processes of said invention, as well as other well-known and available amines, including, e.g., those secondary and tertiary amines listed in U.S. Pat. No: 3,458,282.

The carrier solvents can be chosen from a wide range of organic liquids known to persons skilled in the art which can serve as solvents for said acid-amine active components and which provide for greater ease in handling and extracting control.

Said carrier solvents can be unsubstituted or substituted hydrocarbon solvents in which the organic acid and amine are known to be soluble and which are substantially water-insoluble, e.g., kerosene, mineral spirits, naphtha, benzene, xylene, toluene, nitrobenzene, carbon tetrachloride, chloroform, trichloroethylene, etc. Also higher oxygenated compounds such as alcohols, ketones, esters, ethers, etc., that may confer better homogeneity and fluidity and others that are not acids or amines, but which may confer an operationally useful characteristic, can also be included.

In the process of said invention, the essential operating extractant is believed to be the amine, balanced by a substantially equivalent amount of, strong organic acid. An excess of acid acts as a modifier of the system, and so does an excess of amine, which obviously will be present as salts of acids present in the system. These modifiers are useful in optimization of the extractant, but are not essential.

Thus, as stated, the molar ratio between the two foregoing active constituents lies between 0.5 to 2 and 2 to 0.5, and preferably between about 0.5 to 1 and 1 to 0.5.

According to the invention described and claimed in WO2008/111045, it was surprisingly found that HCl can be distilled out of such an HCl-loaded extractant phase at temperatures below 250° C. without noticeable solvent decomposition.

Thus, said specification describes and claims a process for the recovery of HCl from a dilute solution thereof, comprising:
a) bringing a dilute aqueous HCl solution into contact with a substantially immiscible extractant, said extractant comprising:
   i) an oil soluble amine, which amine is substantially water insoluble both in free and in salt form;
   ii) an oil soluble organic acid, which acid is substantially water insoluble both in free and in salt form; and
   iii) a solvent for the amine and organic acid;
   whereupon HCl selectively transfers to said extractant to form an HCl-carrying extractant; and
b) distilling HCl from said HCl-carrying extractant to form gaseous HCl and HCl-depleted extractant.

The recovery of HCl carried by extractant was described therein with respect to two classes of possible stripping-carriers:
1) inert gas, typically N₂; and
2) steam.

Thus in said application, said “treating” comprised heating at a temperature of up to 250° C. and in especially preferred embodiments described therein said “treating” comprised a combination of heating and introducing a stream of inert gas which was described as being preferably N₂ or introducing steam.

As is known inert gases are effective for stripping—they represent conventional technology and are effective for stripping HCl from HCL-carrying extractant. However, the demands in equipment and operational costs of absorbing the HCl out of a carrier such as N₂ (or CO₂) and recycling the inert carrier present a drawback of this mode of stripping. Furthermore, while water and, generally, aqueous systems are very effective in absorbing the HCl, the N₂ that is thus separated will necessarily carry in it water vapor. The water that is thus recycled decreases the effectiveness where dry HCl is desired.

The use of steam as an inert stripping gas does away with costly recycle since steam condenses to form a liquid water phase and an HCl gas phase. However the liquid phase retains some of the stripped HCl thereby decreasing overall process efficiency.

In Israel Specification 190,704, there is described the fact that it was surprisingly found that the advantages of (1) and of (2) above can be retained with none of their disadvantages by using a hydrocarbon in vapor phase as an inert stripping gas. On cooling the carrier hydrocarbon vapor, it condenses to form a liquid hydrocarbon phase that does not retain any HCl. The HCl is thus recovered fully as a dry HCl phase. Example 1 in said Israel Specification illustrates this finding with a commercial xylene, of 135/145° C. boiling range, as the chosen hydrocarbon vapor.

Thus according to the Israel Specification 190,704 there was described and claimed a process for the recovery of HCl from a dilute solution thereof, comprising:
a) bringing a dilute aqueous HCl solution into contact with a substantially immiscible extractant, said extractant comprising:
   i) an oil soluble amine which amine is substantially water insoluble both in free and in salt form;
   ii) an oil soluble organic acid which acid is substantially water insoluble both in free and in salt form; and
   iii) a solvent for the amine and organic acid;
   whereupon HCl selectively transfers to said extractant to form an HCl-carrying extractant; and
b) introducing a stream of an inert stripping gas comprising a hydrocarbon in vapor phase into said HCl-carrying extractant for conveying the HCl from said extractant phase and for obtaining gaseous HCl.

In preferred embodiments of said invention, said hydrocarbon was selected from the group consisting of aliphatic and aromatic unsubstituted hydrocarbons.

In especially preferred embodiments of said invention, the hydrocarbon was selected for having, at atmospheric pressure, a boiling point at which it is desired to effect the stripping.

It was expected that thermal recovery by “stripping” with an inert gas or vapor would follow similar rules, i.e., that the stronger acid of two acids that are coupled to the same base, will provide a more effective stripping—all else being equal.

As stated hereinbefore with reference to U.S. Pat. No. 4,291,007:

(1) “The strong organic acids envisioned for use in the extractant phase of said invention were organic acids which may be defined and characterized as follows: when 1 mol of the acid in a 0.2 molar or higher concentration is contacted with an equivalent amount of 1N NaCl, the pH of the sodium chloride solution decreases to below 3.

(2) Especially preferred for use in U.S. Pat. No: 4,291,007 were strong organic acids selected from the group consisting of aliphatic and aromatic sulfonic acids and alpha-, beta- and gamma-chloro and bromo-substituted carboxylic acids, e.g., hexadecylsulfonic acid, didodecylnaphthalene disulfonic acid, alpha-bromo lauric acid, beta, beta-dichloro decanoic acid and gamma dibromo octanoic acid, etc.”

In contradistinction to the teachings of said prior art patent, and the expectations from the above rules, it was surprisingly observed that weak acids, having a pKa above 3 and even very weak acids such as aliphatic carboxylic acids, can provide for effective stripping of part of or all of the HCl carried in an extractant wherein the ABC extractant couples a weak acid with an amine.

Stated differently, weak acids such as carboxylic acids were not considered of interest in the practice of the invention as described in U.S. Pat. No. 4,291,007 or even as described in more recent application PCT/IL2008/000278, as constituents of ABC extractants or as constituents of extractants for HCl. Such extractants, when equilibrated with an aqueous HCl phase, provide for powerful distribution in favor of the extractant, which distribution is only marginally affected by temperature. Stripping, i.e. distribution of HCl at higher temperatures in favor of the gas phase that generally parallels the distribution in favor of the aqueous phase, was naturally expected to be ineffective in the case of weak acids as a component of ABC extractants. Surprisingly it has now been found that this parallelism does not apply in the case of carboxylic acids and similar weak acids having a pKa above 3 and that effective stripping can be achieved therewith. Furthermore, the effective extraction of HCl from an aqueous phase, which results in high loading of the extractant, provides for an economically beneficial reduction of the amount of extractant required per unit of HCl.

Thus according to Israel specification 190,703, there is described and claimed a process for the recovery of HCl from a dilute solution thereof, comprising:
a) bringing a dilute aqueous HCl solution into contact with a substantially immiscible extractant, said extractant comprising:
   1) an oil soluble amine, which amine is substantially water insoluble both in free and in salt form;
   2) an oil soluble weak organic acid having a pKa above 3, which acid is substantially water insoluble both in free and in salt form; and
   3) a solvent for the amine and organic acid; whereupon HCl selectively transfers to said extractant to form an HCl-carrying extractant; and
b) treating said HCl-carrying extractant to obtain gaseous HCl.

Thus in contradistinction to the definition of strong organic acids presented in U.S. Pat. No. 4,291,007, the weak organic acids envisioned for use in the extractant phase of said process, are organic acids which may be defined and characterized as follows: when 1 mol of the acid in a 0.2 molar or higher concentration in an organic solvent is contacted with an equivalent amount of NaCl in 1 N aqueous solution, the pH of the sodium chloride solution is greater than about 4 more preferably greater than about 5.

Thus a weak acid according to Israel specification 190,703, e.g. carboxylic acids such as lauric acid, when tested according to the above definition, reduces pH to about 6.

As it will be noted however, both the invention described and claimed in WO2008/111245 and the inventions described in Israel Specification 190,703 and in Israel Specification 190,704, involve and require treating said HCl carrying extractant at an elevated temperature, even though said temperature is below 250° C.

According to the present invention, it has now been discovered that it is possible to extract HCl from said HCl carrying extractant without the need to elevate the temperature thereof.

Thus, more particularly, according to the present invention, there is now provided a process for the recovery of gaseous HCl comprising:
a) providing an HCl-carrying extractant comprising:
   (i) an oil soluble amine which amine is substantially water insoluble both in free and in salt form; and
   (ii) a solvent for the amine and organic acid;
b) contacting said HCl-carrying extractant with at least one non-volatile mineral acid, and
c) stripping gaseous HCl,
   whereby HCl-depleted extractant and gaseous HCl are formed.

In preferred embodiments of the present invention, said HCl-carrying extractant further comprises an oil soluble organic acid which acid is substantially water insoluble both in free and in salt form.

Preferably, the step providing as set forth above, comprises bringing a dilute HCl aqueous solution in contact with an extractant comprising:
(i) an oil soluble amine which amine is substantially water insoluble both in free and in salt form; and
(ii) a solvent for the amine and organic acid;
   whereupon HCl selectively transfers to said extractant to form said HCl-carrying extractant.

Preferably said HCl-carrying extractant further comprises an oil soluble organic acid which acid is substantially water insoluble both in free and in salt form.

In especially preferred embodiments of the present invention the step of providing comprises bringing a chloride aqueous solution in contact with a non-volatile mineral acid and with an extractant comprising:
(i) an oil soluble amine which amine is substantially water insoluble both in free and in salt form; and
(ii) a solvent for the amine and organic acid;
   whereupon HCl selectively transfers to said extractant to form said HCl-carrying extractant.

Preferably, said HCl-carrying extractant further comprises an oil soluble organic acid which acid is substantially water insoluble both in free and in salt form.

In especially preferred embodiments of the present invention, contacting in (b) is with a concentrated solution of said mineral acid.

In the most preferred embodiments of the present invention, said mineral acid is selected from a group consisting of sulfuric acid and phosphoric acid.

Preferably, said contacting in (b) and said stripping in (c) are simultaneous. According to a particularly preferred embodiment, in such simultaneous contacting and stripping, essentially the whole amount of HCl in said HCl-carrying extractant is stripped, forming thereby an essentially HCl-free extractant

Preferably, said contacting in (b) is conducted at a temperature lower than 60° C.

In preferred embodiments of the present invention, HCl partial vapor pressure is greater than 20 mm Hg, more preferably greater than 50 mm Hg, most preferably greater than 100 mm Hg.

Preferably, said contacting in (b) is conduced at sub-atmospheric pressure. Also preferred is carrying out the process wherein said contacting in (b) is conduced in the presence of a carrier gas.

In especially preferred embodiments of the present invention, said contacting forms HCl-depleted extractant and a concentrated HCl aqueous solution optionally also comprising said mineral acid.

In preferred embodiments of the invention, said stripping is from said concentrated HCl solution.

In preferred embodiments of the present process, wherein said HCl-depleted extractant carries said mineral acid, said process further comprises a step of washing at least a portion of said carried mineral acid out of said HCl-depleted extractant.

In some preferred embodiments of the present invention there is provided a process for the recovery of gaseous HCl from an aqueous solution comprising at least one of HCl and a chloride salt, comprising:
a) bringing said aqueous solution into contact with a substantially immiscible extractant, said extractant comprising:
   (i) an oil soluble amine which amine is substantially water insoluble both in free and in salt form;
   (ii) an oil soluble organic acid, which acid is substantially water insoluble both in free and in salt form; and
   (iii) a solvent for the amine and organic acid;
      whereupon HCl selectively transfers to said extractant to form an HCl-carrying extractant;
b) contacting said HCl-carrying extractant with at least one non-volatile mineral acid, and
c) stripping gaseous HCl,
   whereby HCl-depleted extractant and gaseous HCl are formed.

In other preferred embodiments of the present invention there is provided a process for the recovery of gaseous HCl from dilute solution thereof comprising:
a) bringing said aqueous solution into contact with a substantially immiscible extractant, said extractant comprising:
   (i) an oil soluble amine which amine is substantially water insoluble both in free and in salt form;
   (ii) an oil soluble organic acid which acid is substantially water insoluble both in free and in salt form; and
   (iii) a solvent for the amine and organic acid;
      whereupon HCl selectively transfers to said extractant to form an HCl-carrying extractant; and
b) contacting said HCl-carrying extractant with at least one non-volatile mineral acid at selected temperature and condition where gaseous HCl is formed
   whereby HCl-depleted extractant and gaseous HCl are formed.
   In said other preferred embodiments, preferably the selected temperature and condition are such that HCl partial vapor pressure is at least 20 mm Hg, more preferably greater than 50 mm Hg, most preferably greater than 100 mm Hg.

Preferably, said conditions involve at least one of pumping a carrier gas and sub-atmospheric pressure.

In yet another preferred embodiment of the present invention there is provided a process for the recovery of gaseous HCl from dilute solution thereof comprising:
a) bringing said aqueous solution into contact with a substantially immiscible extractant, said extractant comprising:
   (i) an oil soluble amine which. amine is substantially water insoluble both in free and in salt form;
   (ii) an oil soluble organic acid which acid is substantially water insoluble both in free and in salt form; and
   (iii) a solvent for the amine and organic acid; whereupon HCl selectively transfers to said extractant to form an HCl-carrying extractant;
b) contacting said HCl-carrying extractant with at least one non-volatile mineral acid to form HCl-depleted extractant and a concentrated HCl aqueous solution optionally comprising also said mineral acid; and
c) stripping gaseous HCl from said concentrated aqueous solution

Also provided according to the present invention is a process for the recovery of gaseous HCl and for the production of a salt of a mineral acid comprising:
a) forming an aqueous solution by providing an aqueous solution of a chloride salt and by providing a non-volatile mineral acid
b) bringing said aqueous solution into contact with a substantially immiscible extractant, said extractant comprising:
   (i) an oil soluble amine which amine is substantially water insoluble both in free and in salt form;
   (ii) an oil soluble organic acid which acid is substantially water insoluble both in free and in salt form; and
   (iii) a solvent for the amine and organic acid;
      whereupon HCl selectively transfers to said extractant to form an HCl-carrying extractant and an HCl-depleted solution of said salt; separating said HCl-carrying extractant and said HCl-depleted solution of said salt; and
c) recovering gaseous HCl from said HCl-carrying extractant by contacting with at least one non-volatile mineral acid.
   Preferably in this embodiment, said contacting in step (d) is conducted at selected temperature and condition such that HCl partial vapor pressure is at least 20 mm Hg , more preferably greater than 50 mm Hg, most preferably greater than 100 mm Hg.

Preferably, said contacting in step (d) forms a concentrated HCl solution optionally comprising said mineral acid.

In further preferred embodiments of the present invention there is provided a process for the recovery of gaseous HCl and for the production of a MX salt from a mineral acid HX comprising:
a) providing an aqueous solution of a chloride salt MCI
b) bringing said aqueous solution into contact with HX-carrying, substantially immiscible extractant, said extractant comprising:
   (i) an oil soluble amine which amine is substantially water insoluble both in free and in salt form;
   (ii) an oil soluble organic acid which acid is substantially water insoluble both in free and in salt form; and
   (iii) a solvent for the amine and organic acid;
      whereupon HCl selectively transfers to said extractant to form an HCl-carrying extractant and an HCl-depleted solution of MX;
c) separating said HCl-carrying extractant and said HCl-depleted solution of MX; and
d) recovering gaseous HCl from said HCl-carrying extractant by contacting with HX.;
   wherein M is a metal cation and X is an anion of said mineral acid.
   Also in these preferred embodiments, preferably, said contacting in step (d) is conducted at selected temperature and condition such that HCl partial vapor pressure is at least 20 mm Hg, more preferably greater than 50 mm Hg, most preferably greater than 100 mm Hg.

Preferably, said contacting in step (d) forms a concentrated HCl solution optionally comprising said mineral acid.

In other preferred embodiments of the present invention, said contacting in step (d) forms said HX-carrying extractant of step (b).

In especially preferred embodiments of the present invention said process further comprises a step of recovering MX from said separated HCl-depleted solution of MX.

Preferably, said recovering comprises crystallization of MX, whereby crystalline MX and mother liquor are formed and wherein said crystalline MX is separated from said mother liquor.

In preferred embodiments of the present invention the step of providing of step (a) comprises adding MCI to said mother liquor.

The terms “dilute” and “concentrated” as applied to aqueous phases that contain HCl, but not a mineral acid refer only to the w/w rations between HCl and H₂O contained in the aqueous phase. Solutions with H₂O:HCl ratios of about 4 or higher are considered dilute while those with ratios of 3 or lower are considered concentrated.

Thus the process according to the present invention recovers HCl practically completely from any aqueous phase whatever the initial concentration; the key usefulness residing in recovering HCl from aqueous phases of initial azeotropic concentrations and lower.

The terms “extractant” and “ABC extractant” are used herein interchangeably. According to one embodiment, the organic acids envisioned for use in the extractant phase of the present invention are organic acids which may be defined and characterized as follows: when 1 mol of the acid in a 0.2 molar or higher concentration is contacted with an equivalent amount of 1N NaCl, the pH of the sodium chloride solution decreases to below 3.

Also preferred for use in the present invention, are organic acids selected from the group consisting of aliphatic and aromatic sulfonic acids and alpha-, beta- and gamma-chloro and bromo substituted carboxylic acids, e.g., hexadecylsulfonic acid, didodecylnaphthalene disulfonic acid, alpha-bromo lauric acid, beta-, beta-dichloro decanoic acid and gamma dibromo octanoic acid, etc. and organic acids with at least 6, preferably at least 8, and most preferably at least 10, carbon atoms.

According to another embodiment, as described, however, in co-pending Israel Specification 190,703, weak organic acids having a pKa above 3 are used in the extractant of the present invention.

The amines of the present invention are preferably primary, secondary and tertiary amines singly or in mixtures and characterized by having at least 10, preferably at least 14, carbon atoms and at least one hydrophobic group. Such commercially available amines as Primene 81-R, and Primene JM-T (which are primary aliphatic amines in which the nitrogen atom is bonded directly to a tertiary carbon atom) sold by Rohm and Haas Chemical Co.; Amberlite LA-1 and Amberlite LA-2, which are secondary amines sold by Rohm and Haas; Alamine 336, a tertiary tricaprylyl amine (TCA) and Alamine 304, a tertiary trilaurylamine (TLA), both sold by Cognis, Inc., can be used in the processes of the present invention, as well as other well known and available amines including, e.g., those secondary and tertiary amines listed in U.S. Pat. No. 3,458,282. According to a preferred embodiment, tris(2-ethyl hexyl) amine is used as the amine of the extractant of the present invention

The term “solvent,” as used herein, is intended to refer to any water-immiscible organic liquid in which the acid and amine dissolve. Hydrocarbons, alkanols, esters, etc. having the required immiscibility can be used individually or in admixtures.

In preferred embodiments of the present invention, the solvent is a hydrocarbon.

To avoid any misunderstanding, it is to be noted that the term “solvent,” as used herein, relates to the non-amine, non-acid component of the extractant.

The term “pH half neutralization (pHhn),” as used herein refers to an aqueous solution, the pH of which is in equilibrium with the extractant carrying HCl at an HCl-to-amine molar/molar ratio of 1:2.

Thus in especially preferred embodiments of the present invention said mineral acid is sulfuric acid.

According to a preferred embodiment said contacting in step (b) is with concentrated mineral acid solution, preferably aqueous solution of the acaid. As used herein, concentrated aqueous mineral acid solution is an aqueous solution of the acid, wherein the water/acid w/w ratio is less than 2, more preferably less than 1. As used herein, concentrated HCl aqueous solution optionally also comprising said mineral acid means an aqueous solution wherein the water to total acid w/w solution is is less than 2, more preferably less than 1.

According to a preferred embodiment, the present invention provides for producing HCl gas from chlorides—KCl and NaCl representing the two of the readily available sources. These chlorides can be reacted, in aqueous medium, with acids of lesser acid strengths than HCl, such as H₂SO₄ and H₃PO₄ which are readily available.

By way of example, the equilibrium aqueous system that potassium chloride and sulfuric Acid form in an aqueous phase:

2KCl+H₂SO₄ [symbol] K₂SO₄+2HCl

is shifted to the right by contacting with the extractant (E) of the present invention according to the reaction:

2KCl+H₂SO₄+E→K₂SO₄+E2HCl

and the HCl is recovered by stripping the extractant through contacting with H₂SO₄ solution according to the method of the present invention.

While the invention will now be described in connection with certain preferred embodiments in the following example and with reference to the appended figures so that aspects thereof may be more fully understood and appreciated, it is not intended to limit the invention to these particular embodiments. On the contrary, it is intended to cover all alternatives, modifications and equivalents as may be included within the scope of the invention as defined by the appended claims. Thus, the following examples which include preferred embodiments will serve to illustrate the practice of this invention, it being understood that the particulars shown are by way of example and for purposes of illustrative discussion of preferred embodiments of the present invention only and are presented in the cause of providing what is believed to be the most useful and readily understood description of formulation procedures as well as of the principles and conceptual aspects of the invention.

In the drawing:

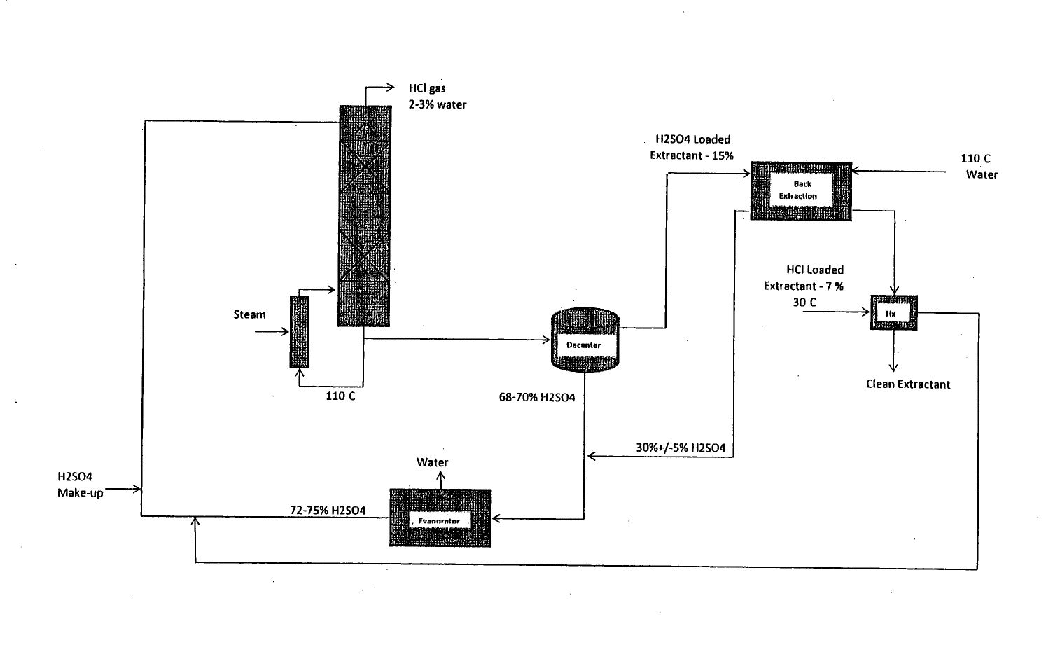

FIG. 1 is a schematic flow diagram for the recovery of HCl using sulfuric acid.

Referring to FIG. 1, this Figure should be viewed in conjunction with the example hereinafter.

### EXAMPLES

### Example 1

### Extractant Composed of Tris(2-Ethyl Hexyl) Amine:

10 Kg/h back-extracted extractant composed of 1 mole/Kg tris(2-ethyl hexyl) amine, 0.5 mol/Kg Caproic acid and 0.5 mol/Kg Lauric acid in dodecane, are contacted at about 30° C. with 2 Kg/h of a 35% HCl aqueous solution in a counter-current operation (not shown in the diagram), Essentially all the HCl is extracted from the aqueous solution and the extractant is loaded to 7% HCl. That extractant, at approximately 30° C. is indirectly contacted [in operation Hx of FIG. 1] with clean (back-extracted) extractant of the same composition exiting the back extraction at about the same flow rate and at approximately 110° C., to preheat it. The cooled back-extracted extractant at 35-45° C. is reused in HCl extraction. The preheated HCl loaded extractant is mixed with a 12 Kg/h stream of Sulfuric acid, 72-75% acid, and fed to a distillation column fitted internally with trays or preferably provided with structured packing. The distillation column is operated with a top pressure of approximately 2.2 bar and a bottom temperature of approximately 110-115° C.

Essentially all the HCl formerly contained in the extractant exits the column as a gas containing approximately 2-3% water at a rate of about 0.8 Kg/h.

The liquid at the bottom of the column is HCl free and the extractant fraction of it is now loaded with H₂SO₄ at approximately 15% acid. The column bottoms are decanted in the Decanter to separate the heavy (aqueous) phase, which is controlled by H₂SO₄ make-up and evaporation to maintain a concentration of H₂SO₄ in the decanter aqueous phase of 68-70%. The H₂SO₄ loaded extractant, which is the Light (organic) phase from the decanter, is fed to back extraction in a counter-current liquid-liquid contactor system that back extracts the acid from the extractant with 5 Kg/h water.

The recovered 33% acid aqueous solution is reconcentrated and recycled to the distillation column. The back-extracted clean extractant exiting the back extraction is hot and used to preheat the HCl loaded Extractant as described above.

It will be evident to those skilled in the art that the invention is not limited to the details of the foregoing illustrative examples and that the present invention may be embodied in other specific forms without departing from the essential attributes thereof, and it is therefore desired that the present embodiments and examples be considered in all respects as illustrative and not restrictive, reference being made to the appended claims, rather than to the foregoing description, and all changes which come within the meaning and range of equivalency of the claims are therefore intended to be embraced therein.

1. A process for the recovery of gaseous HCl comprising:
a) providing an HCl-carrying extractant comprising:
(i) an oil soluble amine which amine is substantially water insoluble both in free and in salt form;
(ii) an oil soluble organic acid, which acid is substantially water insoluble both in free and in salt form and
(iii) a solvent for the amine and for the oil soluble organic acid;
b) contacting said HCl-carrying extractant with at least one non-volatile mineral acid, and
c) stripping gaseous HCl,
whereby an HCl-depleted extractant and gaseous HCl are formed.

2. The process according to claim 1, wherein the molar ratio between said oil-soluble amine and said oil-soluble organic acid is in the range between 0.5 to 2 and 2 to 0.5.

3. The process according to claim 1, wherein providing comprises bringing a dilute HCl aqueous solution in contact with an extractant comprising:
(i) an oil soluble amine which amine is substantially water insoluble both in free and in salt form;
(ii) an oil soluble organic acid, which acid is substantially water insoluble both in free and in salt form; and
(iii) a solvent for the amine and for the an organic acid;
whereupon HCl selectively transfers to said extractant to form said HCl-carrying extractant.

4. (canceled)

5. A The process according to claim 1, wherein providing comprises bringing a chloride aqueous solution in contact with a non-volatile mineral acid and with an extractant comprising:
(i) an oil soluble amine which amine is substantially water insoluble both in free and in salt form;
(ii) oil soluble organic acid, which acid is substantially water insoluble both in free and in salt form; and
(iii) a solvent for the amine and for the an organic acid;
whereupon HCl selectively transfers to said extractant to form said HCl-carrying extractant.

6-7. (canceled)

8. The process according to claim 1, wherein said mineral acid is selected from a group consisting of sulfuric acid and phosphoric acid.

9. The process according to claim 1, wherein said contacting in (b) and said stripping in (c) are simultaneous.

10. The process according to claim 9, wherein said contacting in (b) is conducted at conditions selected from: a temperature lower than 60° C., at sub-atmospheric pressure, in the presence of a carrier gas and combinations thereof.

11. A The process according to claim 9, wherein HCl partial vapor pressure is greater than 20 mm Hg.

12-13. (canceled)

14. A The process according to claim 1, wherein contacting forms an HCl-depleted extractant and a concentrated HCl aqueous solution optionally also comprising said mineral acid and wherein said stripping is from said concentrated HCl solution.

15-17. (canceled)

18. The process for the recovery of gaseous HCl from a dilute aqueous solution thereof comprising:
a) bringing said aqueous solution into contact with a substantially immiscible extractant, said extractant comprising:
(i) an oil soluble amine, which amine is substantially water insoluble both in free and in salt form;
(ii) an oil soluble organic acid, which acid is substantially water insoluble both in free and in salt form; and
(iii) a solvent for the amine and for the organic acid;
whereupon HCl selectively transfers to said extractant to form an HCl-carrying extractant; and
b) contacting said HCl-carrying extractant with at least one non-volatile mineral acid at selected temperature and conditions where gaseous HCl is formed whereby an HCl-depleted extractant and gaseous HCl are formed.

19. A The process according to claim 18, wherein said selected temperature and conditions are such that HCl partial vapor pressure is at least 20 mm Hg.

20-24. (canceled)

25. A process for the recovery of gaseous HCl and for the production of a MX salt from a mineral acid HX comprising:
a) providing an aqueous solution of a chloride salt MCl;
b) bringing said aqueous solution into contact with an HX-carrying, substantially immiscible extractant, said extractant comprising:
(i) an oil soluble amine, which amine is substantially water insoluble both in free and in salt form;
(ii) an oil soluble organic acid, which acid is substantially water insoluble both in free and in salt form; and
(iii) a solvent for the amine and for the organic acid;
whereupon HCl selectively transfers to said extractant to form an HCl-carrying extractant and an HCl-depleted solution of MX;
c) separating said HCl-carrying extractant and said HCl-depleted solution of MX; and
d) recovering gaseous HCl from said HCl-carrying extractant by contacting with HX wherein M is a metal cation and X is an anion of said mineral acid.

26. The process according to claim 25, wherein said contacting in step (d) is conducted at selected temperature and condition such that HCl partial vapor pressure is at least 20 mm Hg.

27. (canceled)

28. The process according to claim 25, wherein said contacting in step (d) forms said HX-carrying extractant of step (b).

29. The process according to claim 25, further comprising a step of recovering MX from said separated HCl-depleted solution of MX, wherein said recovering comprises crystallization of MX1 whereby a crystalline MX and mother liquor are formed and wherein said crystalline MX is separated from said mother liquor and wherein said providing of step (a) comprises adding MCl to said mother liquor.

30-32. (canceled)
